(19) United States
(12) Patent Application Publication
(10) Pub. No.: US 2022/0083014 A1
(43) Pub. Date: Mar. 17, 2022

(54) REMOTE-OPERATED INTELLIGENT MICROCOMPUTER LIGHT SWITCH THAT CAN FULLY REPLACE CONVENTIONAL SWITCHES

(71) Applicant: Chou Tsai-Fu, Taipei City (TW)

(72) Inventor: Chou Tsai-Fu, Taipei City (TW)

(21) Appl. No.: 17/021,433

(22) Filed: Sep. 15, 2020

(51) Int. Cl. G05B 19/042; H02B 1/42

(52) U.S. Cl. CPC G05B 19/042; H02B 1/20; H02B 1/42

(57) ABSTRACT

The present invention provides a remote-operated intelligent microcomputer light switch that can fully replace conventional switches, which can execute the on/off function of general wall switches, and different remote settings and operations can be performed through a smart device. The switch comprises an ornamental panel; an operation core; a button area providing touch switch function, combined with a LED indicator light to display status, an embedded battery supplies power for persistent operation, and contacts identical with general wall switches; a control pedestal, embedded with a control circuit abutting connecting terminals on the operation core to obtain control signal, and the high and low tension circuits are completely isolated to avoid the risk of electric shock. There are foolproof locking holes in the upper and lower parts of the framework of the control pedestal, which can fix the operation core in a fixed direction to avoid vertical reversal. The operation core engages with the control pedestal, and then they are integrated with the ornamental panel, so as to achieve touch function and remote operation with a smart device, and to implement technicalized life of smart home to upgrade the quality of life.

### BACKGROUND OF INVENTION

### 1. Field of the Invention

The present invention relates generally to a new generation wall switch with intelligent control function developed by improving the structure of conventional wall switch, and more particularly to an intelligent microcomputer light switch that can be completely compatible with conventional switch contacts without an external power supply, and can be remotely operated on a smart phone or a tablet PC.

### 2. Description of Related Art

The known switches are used for a number of electrical equipment in family life, and light switches fixed to walls can be seen everywhere indoors and outdoors, for turning on or off lighting fixtures or electrical equipments. This kind of light switch is mechanical switch, using metal spring tabs to conduct electricity by contact points to light a lamp.

The aforesaid common light switches have been existing for years and practical, but there are still some deficiencies according to practical review, analyzed below. 1) The conventional light switches are mostly provided with internal elastic elements, mechanically turned on and off, only for on or off function. 2) In terms of structure design of a conventional light switch, there are gaps between the panel and button, where the contaminants are likely to be stuck in, difficult to be cleaned. 3) There are gaps between the panel and button of a conventional light switch, the button protrudes from the panel, if the user contacts the button with a wet hand, there may be an accidental electric shock, inducing safety problems. 4) The panels and buttons of conventional light switches are usually in fixed shapes, stiff, meaningless and short of shape design, they are sometimes incompatible with the newly decorated rooms.

Moreover, with continuous innovation of technology, electronically controlled light switches came out. However, the embedded wall electronic switches are only applicable to new power distribution decoration or unavailable at all as the conventional light switches are not provided with supply wires. Recently, a product using the voltage drop between single live wire and load as AC phase cutting to obtain power for operating the electronic switches came out. However, as limited to the high impedance of LED lighting energy-saving bulbs, there are sometimes LED lamp flicker, uncertain or unstable actuation.

According to the above description, there are defects in conventional light switches, and the electronic switches cannot be applicable to all the LED energy-saving lamps for power problems, it is still an urgent issue to be solved by the persons familiar with this technology up to now. In view of this, the inventor of this project proposed a brand new “remote-operated intelligent microcomputer light switch that can fully replace conventional switches”, which can solve the aforesaid defects, and can be operated remotely on a smart tablet or a smart phone, making the life more convenient and enhancing vital functions, and it is expected to benefit common people.

### SUMMARY OF THE INVENTION

The first object of the present invention 1s to provide a remote-operated intelligent microcomputer light switch that can fully replace conventional switches, the on/off of a lamp is controlled by touch, and the panel and the touch switch are designed in one, reducing contaminants and easy to clean, and preventing the user from getting an accidental electric shock to achieve high safety.

The second object of the present invention is to provide a remote-operated intelligent microcomputer light switch that can fully replace conventional switches, which has touch control and smart phone and tablet PC remote operation functions, power by general battery, based on high-tech low power consumption design, the battery life can be longer than 1 year (depending on frequency of use), breaking the limitation of general smart switch which cannot work until the original light switch is provided with a set of supply wire.

The third object of the present invention is to provide a remote-operated intelligent microcomputer light switch that can fully replace conventional switches, using the contact characteristic of lockup relay, it can be used in the design of simple tangent and bitangent switch circuits, it can fully replace the existing mechanical switches and the electronic switches with difficult power distribution, it can be operated by smart devices, the use is more convenient, it can fully replace the existing switches, and the contacts are completely compatible.

The fourth object of the present invention 1s to provide a remote-operated intelligent microcomputer light switch that can fully replace conventional switches, besides general on/off control, it can be equipped with free Apps for multifunctional intelligent operation, such as sleep timed off, programmable energy-saving timed on or off, anti-theft function, room name setting, vacation function setting and so on, with plain operation frames, it can be easily operated by a smart device to implement smart home control.

To achieve the aforesaid purposes and effects, the inventor of this project designed a remote-operated intelligent microcomputer light switch that can fully replace conventional switches, which generally comprises an ornamental panel with an open slot; an operation core formed of an upper case, a lower case and a circuit structure to provide touch function, communication function and intelligent operation function, the surface of the upper case is a touch switch, the opposite surface of lower case has a slot for placing the battery; and a control pedestal formed of a surface plate, abase and a circuit composite structure, the circuit composite structure is embedded in the base, a surface margin combined with the ornamental panel is formed around the opening, the surface plate is combined with the operation core.

Said circuit structure comprises a touch control switching circuit, a LED indicator light and a microchip intelligent communication module and connector.

The surface of said operation core can be provided with at least two convex lines and grooves in different shapes, or divided into multiple touch switches by screen printing.

The surface of the button area is screen printed, the convex lines or grooves can be designed as straight lines, circular arcs, geometric patterns or pattern combinations.

The surface of the status display area of the operation core is provided with a through hole.

Two opposite sides around the operation core are provided with locating points and dentate slots corresponding to different shapes. The inner side face of the opening of the base of the control pedestal is provided with foolproof locking holes. The ornamental panel is provided with dentate tenons.

A row of wire holder slots is designed in the base, isolated by plastic material.

Said circuit composite structure comprises a relay, a PC board, a connector and copper terminals of special design. The copper terminals are laid around the relay, and one end is soldered on the contact pin of the relay, the other end is provided with a wire holder of 0-shaped ring structure and with a screw.

Said light switch has a smart device with a built-in App.

Said App is provided for controlling multiple light switches, and the quantity of the light switches can be increased or reduced at any time, the following functions can be set up separately for each light switch, including setting daily switch time sequence, setting weekly switch time sequence, setting sleep mode, countdown function, activating anti-theft function, setting vacation mode, energy-saving or anti-theft, setting the name of each light switch, setting the operation password of each light switch to maintain an independent space.

### BRIEF DESCRIPTION OF THE DRAWINGS

FIG. 1 is the outside view of the light switch of the present invention.

FIG. 2 is the exploded diagram of the light switch of the present invention.

FIG. 3 is the top view of the base of control pedestal of the light switch of the present invention.

FIG. 4 is the assembly diagram (1) of the light switch of the present invention.

FIG. 5 is the assembly diagram (2) of the light switch of the present invention.

FIG. 6 shows the assembled light switch of the present invention.

FIG. 7 is the schematic diagram of the App for the light switch with a smart device.

FIG. 7 (a) is the function diagram of the App of the present invention (1).

FIG. 7 (b) is the function diagram of the App of the present invention (2).

FIG. 7 (c) is the function diagram of the App of the present invention (3).

FIG. 7 (d) is the function diagram of the App of the present invention (4).

FIG. 7 (e) is the function diagram of the App of the present invention (5).

FIG. 7 (f) is the function diagram of the App of the present invention (6).

FIG. 7 (g) is the function diagram of the App of the present invention (7).

### DETAILED DESCRIPTION OF THE INVENTION

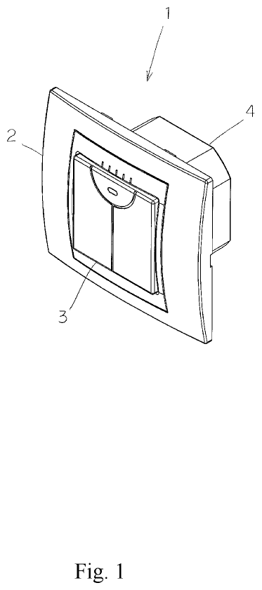

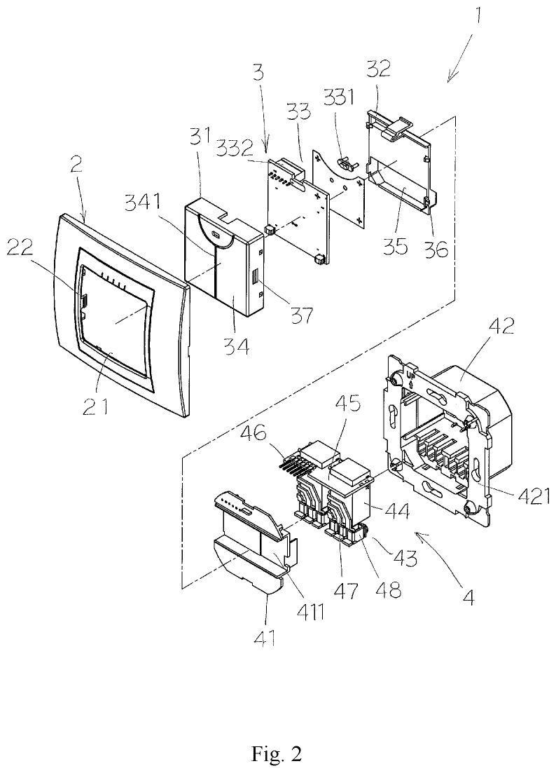

First, as shown in FIGS. 1 and 2, the present invention provides a remote-operated intelligent microcomputer light switch that can fully replace conventional switches, the light switch (1) generally comprises a mutually matched ornamental panel (2), an operation core (3) and a control pedestal (4).

As shown in FIG. 2, the ornamental panel (2) has an open slot (21) for fixing a part of the operation core (3), and the operation core (3) protrudes from the surface of the ornamental panel (2); the opposite inner faces around the open slot (21) of the ornamental panel (2) are provided with dentate tenons (22) for positioning the operation core (3), so that the two items are unlikely to be separated after combination.

As shown in FIG. 2, the operation core (3) comprises an upper case (31), a lower case (32) and a circuit structure (33). The circuit structure (33) is embedded in the space between the upper and lower cases (31, 32), including a touch control switching circuit, a LED indicator light (331) and a microchip intelligent communication module and connector (332), so as to provide touch function, communication function and intelligent operation function. The surface of the operation core (3) is provided with at least two convex lines (341) in different shapes and divided into one or more than one touch switch (34), and the division can be changed as required. There are two symmetric touch switches (34) in this embodiment. The convex lines (341) can be grooves or multiple touch switches can be divided by screen printing, and the shape of the convex line, groove or screen-printed touch switch (34) can be designed as straight line, circular arc, geometric pattern or pattern combination. The surface of the lower case (32) is provided with a slot (35) as the space for placing electronic parts, so that the lower case (32) combined with the circuit structure (33) can be combined with the upper case (31) smoothly. In addition, two opposite sides around the operation core (3) are provided with locating points (36) corresponding to different shapes for engaging with the control pedestal (4), as well as dentate slots (37) for engaging with the ornamental panel (2).

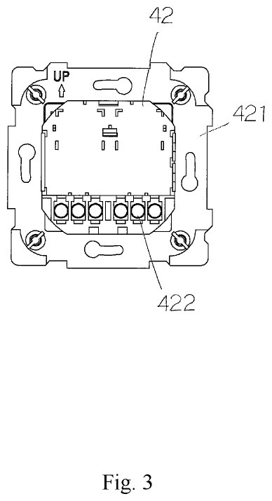

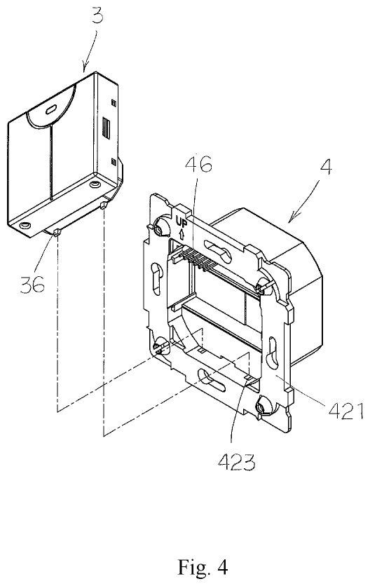

As shown in FIGS. 2 and 3, the control pedestal (4) has a surface plate (41) with a slot (411), so that it can be combined with the operation core (3) smoothly with a battery; a base (42) which can be combined with the surface plate (41), a surface margin (421) combined with the ornamental panel (2) is formed around the opening of the base (42); a circuit composite structure (43) disposed in the base (42), a row of wire holder slots (422) is designed in the base (42), each wire holder slot (422) is isolated by plastic material to prevent electrically short circuit during wiring, and the inner side face of the opening circumference of the base (42) is provided with a set of opposite foolproof locking holes (423). The circuit composite structure (43) comprises a relay (44), a PC board (45), a pin header (46) and copper terminals (47) of special design. The copper terminals (47) are laid around the relay (44) in special design, one end is soldered on the contact pin of the relay (44), the other end is provided with a wire holder of 0-shaped ring structure with a screw (48), so that the external wire terminal can penetrate the ring structure and be tightened by the screw.

As shown m FIG. 46, according to the assembly of the aforesaid units, to put the operation core (3) in the control pedestal (4), the locating point (36) on one side of the operation core (3) can be directly embedded in the foolproof locking hole (423) in the inner side of opening circumference of base (42) of the control pedestal (4), and the connector (332) of the operation core (3) is combined with the pin header (46) in the control pedestal (4) for electrical connection, the ornamental panel (2) is coordinated with the surface margin (421) of the control pedestal (4), and the open slot (21) fixes the operation core (3), the dentate tenons (22) engage with the opposite dentate slots (37), thus, a complete touch light switch (1) is assembled.

The contacts on the back of the base of the control pedestal in the light switch of the present invention are fully compatible with conventional switches, so in implementation, the existing wall switch can be directly transformed into an intelligent microcomputer light switch, which is powered by battery, it is unnecessary to reconfigure the wall switch power supply, or to extract power supply from single live wire terminal cutting phase angle, it can fully replace the existing conventional switches and solve the defects in the existing civilian electronic switches. Moreover, said intelligent microcomputer light switch uses battery feed to drive the lockup relay, and the NO and NC contacts of relay are completely compatible with conventional wall switch contacts, which can replace the simple tangent or bitangent loop of conventional switches.

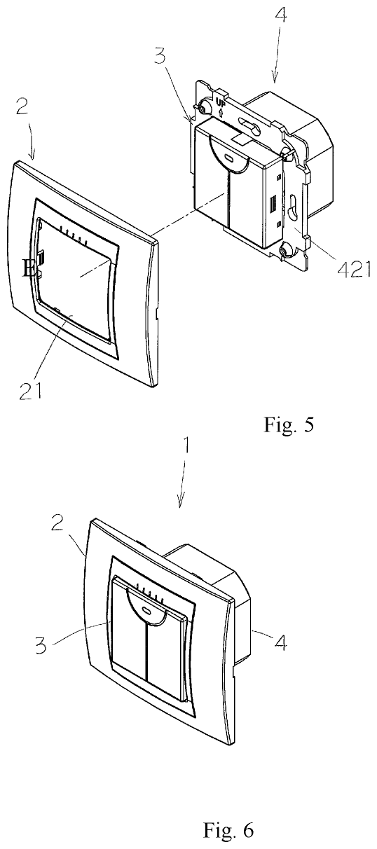

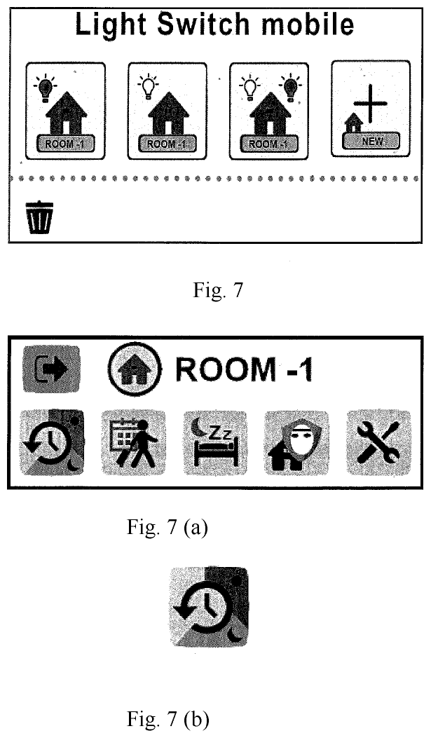

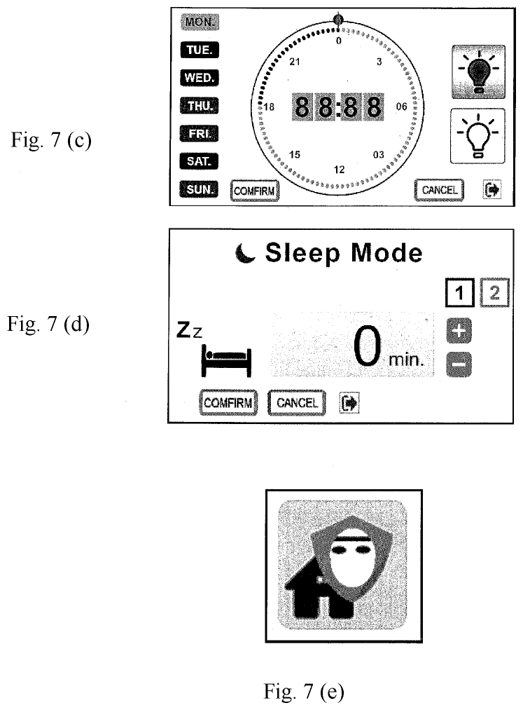

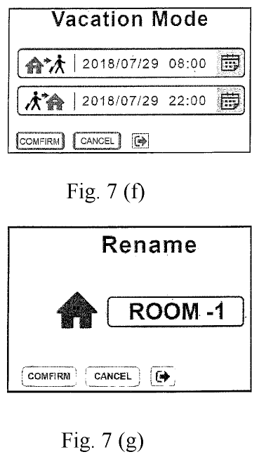

As shown in FIG. 7, in practice, the light switch can be controlled by hand touch, and it can be connected to a smart device, e.g. mobile phone, and then the user can choose the function to be executed or set time sequence of autocontrol according to the functional frame displayed by the built-in App, and operate the switch through the user friendly interface of the smart device, so as to enjoy the convenience brought by technicalization and step into the era of smart home.

As shown in FIG. 7 (a), multiple light switches can be operated, each room can be set up (ROOM X), and the quantity of the light switches (1) can be increased or reduced at any time, there will be no interference phenomenon.

As shown in FIG. 7 (b)(g), each light switch (ROOM X) can be set up separately, e.g. the format of picture display, and the following functions can be set up, including 1, setting daily switch time sequence, multiple times of on or off, operating according to the preset time sequence; 2, setting weekly switch time sequence, the settings can be the same every day, or different every day; 3, setting sleep mode, countdown function; 4, activating anti-theft function, random on or off, preventing break-in; 5, setting vacation mode, energy-saving or anti-theft; 6, setting the name of each light switch to prevent confusion; 7, setting the operation password of each light switch to maintain independent space.

According to the above description, the intelligent light switch of the present invention can perform the on/off function of general switches, and it can be linked with smart devices to perform remote settings and control, such as sleep timed off, energy-saving timed on or off, anti-theft function, room name setting, vacation function setting and so on. Secondly, in the structure design of the light switch, the built-in battery and high-tech low power consumption technology break through the blind spot of general electronic wall switches which use voltage drop to cut AC phase to extract power, but inapplicable to LED energy-saving bulbs. The contacts identical with conventional light switches are provided, the existing conventional switches and electronic switches are replaced completely, the new age of smart control is stepped in directly. In addition, the complete isolation design can avoid the risk of electric shock, with the foolproof design for various components, the assembly is more convenient. Moreover, the LED indicator light displays the operating state and the on-line state of smart device, achieving technicalized life of smart home and upgrading the quality of life.

Although the invention has been explained in relation to its preferred embodiment, it is to be understood that many other possible modifications and variations can be made without departing from the spirit and scope of the invention as hereinafter claimed.

1. A remote-operated intelligent microcomputer light switch that can fully replace conventional switches, comprising
an ornamental panel with an open slot;
an operation core, comprising an upper case, a lower case and a circuit structure to provide touch function, communication function and intelligent operation function, the surface of the upper case is a touch switch, the opposite surface of lower case has a slot for placing battery; and
a control pedestal, comprising a surface plate, a base and a circuit composite structure, the circuit composite structure is embedded in the base, and a surface margin combined with the ornamental panel is formed around the opening, the surface plate is combined with the operation core.

2. The remote-operated intelligent microcomputer light switch that can fully replace conventional switches defined in claim 1, wherein the circuit structure comprises a touch control switching circuit, a LED indicator light and a microchip intelligent communication module and connector.

3. The remote-operated intelligent microcomputer light switch that can fully replace conventional switches defined in claim 1, wherein the surface of the operation core can be provided with at least two convex lines and grooves in different shapes, or divided into multiple touch switches by screen printing.

4. The remote-operated intelligent microcomputer light switch that can fully replace conventional switches defined in claim 3, wherein the screen printing, convex line or groove design on the surface of the button area can be straight line, circular arc, geometric pattern or pattern combination.

5. The remote-operated intelligent microcomputer light switch that can fully replace conventional switches defined in claim 1, wherein the surface of status display area of the operation core is provided with a through hole.

6. The remote-operated intelligent microcomputer light switch that can fully replace conventional switches defined in claim 1, wherein two opposite sides around the operation core are provided with locating points and dentate slots corresponding to different shapes, the inner side face of the base opening of the control pedestal is provided with foolproof locking holes, the ornamental panel is provided with dentate tenons.

7. The remote-operated intelligent microcomputer light switch that can fully replace conventional switches defined in claim 1, wherein a row of wire holder slots is designed in the base, which is isolated by plastic material.

8. The remote-operated intelligent microcomputer light switch that can fully replace conventional switches defined in claim 1, wherein the circuit composite structure comprises a relay, a PC board, a connector and copper terminals of special design; the copper terminals are laid around the relay, one end is soldered on the contact pin of the relay, the other end is provided with a wire holder of O-shaped ring structure with a screw.

9. The remote-operated intelligent microcomputer light switch that can fully replace conventional switches defined in claim 1, wherein the light switch involves a smart device with a built-in App.

10. The remote-operated intelligent microcomputer light switch that can fully replace conventional switches defined in claim 9, wherein the App is provided for operating multiple light switches, and the quantity of the light switches can be increased or reduced at any time, the following functions can be set separately for each light switch, including setting daily switch time sequence; setting weekly switch time sequence; setting sleep mode, countdown function; activating anti-theft function; setting vacation mode, energy-saving or anti-theft; setting the name of each light switch; setting the operation password of each light switch to maintain independent space.
